(19) United States
(12) Patent Application Publication
(10) Pub. No.: US 2022/0082817 A1
(43) Pub. Date: Mar. 17, 2022

(54) OPTICAL BEAM SCANNERS HAVING MULTIPLE LOOP SCANNERS THEREIN AND METHODS OF OPERATING SAME

(71) Applicant: Mirada Technologies Inc., San Francisco, CA (US)

(72) Inventors: Jonathan King Mapel, San Francisco, CA (US); Andrew Carl Miner, Daly City, CA (US)

(21) Appl. No.: 17/466,668

(22) Filed: Sep. 3, 2021

Related U.S. Application Data
(60) Provisional application No. 63/077,886, filed on Sep. 14, 2020.

(51) Int. Cl. G02B 26/10

(52) U.S. Cl. CPC G02B 26/101

(57) ABSTRACT

An optical beam scanner includes a first optical beam steering device having a first surface thereon, which is configured to redirect a first optical beam incident thereon through reflection, refraction and/or diffraction of the first optical beam, and a second optical beam steering device having a second surface thereon, which is configured to reflect the redirected first optical beam incident thereon at a scanning target when both first and second surfaces are rotating about respective first and second axes of the first and second optical beam steering devices and the redirected first optical beam is tracing an uninterrupted loop on the second surface. The first optical beam steering device may be configured as a first monogon, a first prism, or a first grating, and the second optical beam steering device may be configured as a second monogon. The first and second axes may be collinear.

### REFERENCE TO PRIORITY APPLICATION

This application claims priority to U.S. Provisional Application Ser. No. 63/077,886, filed Sep. 14, 2020, the disclosure of which is hereby incorporated herein by reference.

### FIELD OF THE INVENTION

The invention relates to scanned optical beams for use in remote sensing and other applications.

### BACKGROUND

Directing beams of light in specific directions has many applications, and many technologies exist that can accomplish this task. Light, also known as radiation, may be composed of a broad distribution of wavelengths (broad band), such as white light, or may be a very narrow band of wavelengths, such as produced from a typical laser (narrow band). The wavelengths that compose light may be in the visible range, detectable by our eyes, or outside the visible range. Light just beyond the visible range on the long wavelength side of the spectrum is known as infra-red radiation. Light just beyond the visible range on the short wavelength side of the spectrum is known as ultra-violet.

Beams of light may be directed by various means, but directing light by means of a reflecting, movable surface, or mirror, is the most relevant to the present invention. A technology that can provide a reflective surface, and move that reflective surface in a controlled, high speed manner can find application in uses such as microscopy, projection displays, laser sensors, Light Detection and Ranging (LiDAR) and similar. Should these technologies be enabled in a manner that makes them immune from distortion or damage due to external vibrations, accelerations, and gravitational orientations, the technologies become useful in a broader range of harsh conditions.

There are a number of actuation technologies known in the prior art that, when coupled to reflective mirrors, provide controlled beam steering.

There are a variety of methods for actuation that utilize electromagnetic effects. One method of directing light in a controlled manner at high speeds uses an electromagnetic device known as a galvanometer. This technology uses permanent magnets and/or ferromagnetic materials with electrical coils. Electrical current driven through the device initiates motion that can be controlled in a closed loop or open loop control system. This actuation technology coupled to a mirror can provide a high speed mechanism to control and direct light.

It has been observed that galvanometer based technology consume significant electrical power under operation, making them incompatible for applications where electrical power is constrained. The electrical power consumption is largely a function of the mass of the mirror being moved, and the fact that significant energy is expended to accelerate the mirror to a position, then decelerate the mirror to stop at the desired position. The back and forth oscillatory nature of the devices is not as energetically favorable with respect to a technology that continuously rotates. It has been further observed that the mechanical complexity of the construction of galvanometer technology limits the ability to miniaturize this technology at low cost.

Light can also be directed in a controlled manner using mirror systems driven by voice coil motors. Voice coil motors are a simple electrical device, which are similar to a galvanometer, and sometimes also called a solenoid. Electrical energy applied to the windings drives a core linearly, driven by magnetic repulsion. Voice coil motors coupled to the edges of a mirror can be actuated in a controlled manner to tilt the mirror and effectively direct light.

It has been observed that voice coil mirror systems can consume significant amounts of electrical power, and given that they have multiple parts including fine electrical windings, they are difficult to miniaturize at low cost. The electrical power consumption is largely a function of the mass of the mirror being moved, and the fact that significant energy is expended to accelerate the mirror to a position, then decelerate the mirror to stop at the desired position. The back and forth oscillatory nature of the devices is not as energetically favorable with respect to a technology that continuously rotates.

Another technology that uses reflective surfaces for directing light in a controlled manner is electrostatic actuation. This technology uses that fact that when voltage is applied across two surfaces at close proximity, positive and negative charges collect on the respective surface, and an attractive force is generated. This actuation effect can applied in a beam steering technology by using the force generated, and the resulting motion of attractive surfaces to change the angle of a mirror.

It has been observed that electrostatic actuation results in small movements, which in turn, even when mechanically amplified into larger angles, results in modest angles of motion in the mirror.

Piezoelectric effects also can be coupled to a mirror for beam steering. Certain materials expand when subject to high voltages, in a process known as the piezoelectric effect. It has been observed that mirror systems driven by piezoelectric effects, similar to electrostatic actuators, deliver modest angles of motion in the mirrors.

Electrothermal actuation can be used to drive controlled angular deflection in mirrors. This class of device takes advantage of the fact that most materials expand in length when heated. By careful design, electrical power can be dissipated selectively in electrothermal actuators to produce bending or linear extension. This motion can then be coupled with mirrors to deliver a beam steering effect.

It has been observed that electrothermal actuators are relatively slow, and do not produce high speed precision motion relative to other technologies. Additionally, they typically consume significant electrical power in order to generate the high temperatures in regions of the actuators. In order to produce high temperatures and the associated thermal expansion more efficiently, some of these products package the actuators in a vacuum or in low thermal conductivity gasses, adding to the cost of the product.

The aforementioned actuation technologies that allow for the controlled steering of light can be realized using several different manufacturing technologies. These technologies can be manufactured by traditional means, including machining, electrical winding, and hand assembly. Additionally, these beam steering technologies can be realized using semiconductor-like fabrication technologies, known as Micro-Electro-Mechanical Systems (MEMS).

As these devices are miniaturized, typically the actuation speeds that can be realized increase, due to the reduction in the amount of mass in motion. It has been observed that traditional manufacturing methods such as used in galvanometers and voice coil technologies do not scale down to small size in a cost effective manner. MEMS manufacturing technology has the capability of forming high precision mechanical structures at sub millimeter scales, but it has been observed that the beam steering devices manufactured using MEMS fabrication, even when produced on large silicon wafers, do not achieve sufficiently low cost in high production volume. This is generally due to the complexity of each manufacturing step, the number of manufacturing steps, and the complex equipment used. It has been observed that actuators using MEMS manufacturing technologies results in angle movements with magnitudes that may be not sufficient for many ranging applications.

Another technology that is effective in directing beams of light in a controlled manner is known as a polygonal scanner, in which a polygon with reflective outer surfaces is rotated. Incident light reflecting of the rotating polygon's perimeter is scanned in three dimensional (3D) space based on the polygons speed, number of outer sides, and the angle of each mirror side. This approach is energetically favorable with respect to the oscillatory technologies where a mirror is accelerated and decelerated back and forth, but lacks the ability for the mirror to maintain a fixed position if required. Polygonal scanner mirrors are typically mounted on a shaft on bearings, and is rotated using an electromagnetic motor. Polygonal scanners may be simply a rotating plane with one or two sides that are reflective, or be a multi sided polygon with dozens to hundreds of reflective faces on the perimeter. Typical mirrors found in these devices have three to eight sides. The mirrors rotate on bearings that may be based on ball bearings or air bearing technology. Polygonal mirrors have found broad application in markets such as bar code readers, 3D imaging, LiDAR, laser printing, and light shows for entertainment purposes. Polygonal mirrors are typically formed in lightweight metals such as aluminum, but some applications use copper for high speed stability at lower rotation speeds. For low cost application the polygonal mirrors are formed with plastics. The outer reflective surfaces are formed with the economic and optical needs of the application in mind, and typically include aluminum, gold, silver, or nickel.

### SUMMARY OF THE INVENTION

According to some embodiments of the present invention, an optical beam scanner includes a first beam steering device and a second beam steering device. The first beam steering device includes a first surface configured to redirect a first optical beam incident thereon through reflection, refraction, and/or diffraction of the first optical beam. The first surface is rotated about a first axis of rotation of the first beam steering device. The second beam steering device includes a second surface configured to reflect the redirected first optical beam incident thereon. The second surface is rotated about a second axis of rotation of the second beam steering device. The redirected first optical beam traces an uninterrupted loop on the second surface.

In some embodiments, the first optical beam steering device is configured as a first monogon or a first prism or a first grating. In some embodiments, the second optical beam steering device is configured as a second monogon.

In some embodiments, the first and second axes of rotation are collinear.

In some embodiments, the first surface is a mirrored surface.

In some embodiments, the second surface is a mirrored surface.

In some embodiments, the first light source is configured to project the first optical beam to a first portion of the first surface.

In some embodiments, the first prism is disposed between the first light source and the second monogon.

In some embodiments, a second light source is present and is configured to project a second optical beam to a second portion of the first surface.

In some embodiments, the first surface is configured to reflect, refract, or diffract the second optical beam.

In some embodiments, the second surface is configured to redirect the reflected, refracted, or diffracted second optical beam incident thereon at a scanning target.

In some embodiments, the first surface is rotated about a first axis of rotation of the first optical beam scanning device.

In some embodiments, the second surface is rotated about a second axis of rotation of the second optical beam scanning device.

In some embodiments, the first and second portions of the first surface partially overlap.

In some embodiments, an optical beam scanner includes a first optical beam scanning device has a first surface thereon, which is configured to reflect, refract or diffract a first optical beam incident thereon.

In some embodiments, an optical beam scanner includes a second optical beam scanning device having a second surface thereon, which is configured to redirect the reflected, refracted or diffracted first optical beam incident thereon at a scanning target, by implementing a method of operating, which includes rotating the first and second optical beam steering devices about respective first and second axes, and at respective first and second unequal rates.

In some methods, the first rate is greater than the second rate.

In some methods, the first rate is at least four times greater than the second rate.

In some methods, the first optical beam steering device is configured as a first monogon, a first prism, or a first grating.

In some methods, the second optical beam steering device is configured as a second monogon.

In some methods, the first and second axes of rotation are collinear.

In some methods, the first surface is a mirrored surface.

In some methods, the second surface is a mirrored surface.

In some methods, the scanner includes a first light source that is configured to project the first optical beam to a first portion of the first surface.

In some methods, the scanner includes a first prism disposed between the first light source and the second monogon.

In some methods, the scanner further includes a first light source configured to project the first optical beam to a first portion of the first surface.

In some methods, the scanner further includes a second light source configured to project a second optical beam to a second portion of the first surface.

In some methods, the scanner includes the first surface configured to reflect, refract or diffract the second optical beam.

In some methods, the scanner includes the second surface configured to redirect the reflected, refracted or diffracted second optical beam incident thereon at a corresponding scanning target, during rotation of the second surface.

In some methods, the first and second portions of the first surface partially overlap.

### BRIEF DESCRIPTION OF THE DRAWINGS

The accompanying drawings, which are incorporated in and form a part of this specification, illustrate various embodiments of the invention and, together with the description, serve to explain the principles of the invention:

FIG. 1 is a schematic representation of a rotating monogon beam scanner.

FIG. 2 illustrates the scan pattern for two variations of facet angle of a rotating monogon beam scanner.

FIG. 3 is a schematic representation of a rotating monogon beam scanner.

FIG. 4 illustrates the scan pattern for two variations of beam angle of a rotating monogon beam scanner.

FIG. 5 is a schematic representation of a dual rotating monogon beam scanner.

FIGS. 6A and 6B illustrate scan patterns generated by a dual rotating monogon beam scanner for a collection of rotation speeds.

FIG. 7 is another schematic representation of a dual rotating monogon beam scanner.

FIGS. 8A and 8B illustrate scan patterns generated by a dual rotating monogon beam scanner for a collection of rotation speeds.

FIG. 9 is a schematic representation of a dual rotating monogon beam scanner with two independent beams.

FIG. 10A, FIG. 10B and FIG. 11 illustrate scan patterns for a dual rotating monogon beam scanner with two independent beams for a collection of rotation speeds.

FIG. 12 is a schematic representation of a dual rotating optical element beam scanner comprised of a prism and a reflective monogon.

FIGS. 13A and 13B illustrate scan patterns for a dual rotating optical element beam scanner comprised of a prism and a reflective monogon for a collection of rotation speeds.

FIG. 14 is another schematic representation of a dual rotating optical element beam scanner comprised of a prism and a reflective monogon with two independent beams.

FIG. 15A, FIG. 15B and FIG. 16 illustrate scan patterns for a dual rotating optical element beam scanner comprised of a prism and a reflective monogon with two independent beams for a collection of rotation speeds.

FIG. 17 is another schematic representation of a dual rotating optical element beam scanner comprised of a grating and a reflective monogon with two independent beams.

FIG. 18 illustrates a scan pattern for a dual rotating optical element beam scanner comprised of a prism and a reflective monogon with a single beam, where the rotation speed of the two optical elements differ by approximately 4% (e.g., within 5%).

FIG. 19 illustrates scan patterns for a dual rotating optical element beam scanner comprised of a prism and a reflective monogon with a single beam, where the rotation speed of the two optical elements are matched, but have differing degrees of rotational phase offsets (e.g., 0°, 90°, and) 180°.

### DETAILED DESCRIPTION OF THE INVENTION

Reference will now be made in detail to embodiment(s) of the present invention. While the invention will be described in conjunction with the embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, and components may not have been described in detail as not to unnecessarily obscure aspects of the present invention. Specific structural and functional details disclosed herein are not to be interpreted as limiting, but merely as a basis for the claims and as a representative basis for teaching one skilled in the art to variously employ the present disclosure in virtually any appropriately detailed structure.

The terms “a” or “an,” as used herein, are defined as one or more than one. The term “another,” as used herein, is defined as at least a second or more. The terms “including” and/or “having”, as used herein, are defined as comprising (i.e., open transition).

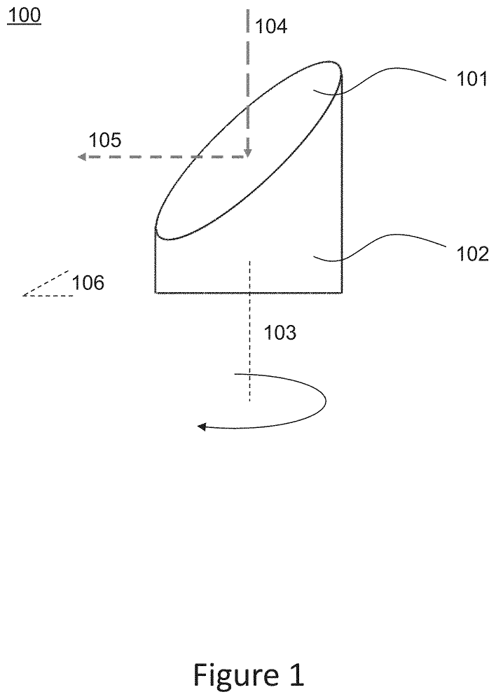

A scan mirror of the family of polygonal mirror scanning systems with only one mirrored facet is called a monogon, or truncated mirror. In a typically drum scanning application, a light beam is directed toward a monogon along the rotation axis and the scanned beam sweeps a circle on an internal drum as the scanner rotates, schematically illustrated in FIG. 1. Monogon mirror 100 is has one reflective facet 101 and other non reflective surfaces, such as 102, both of which rotate about the axis of rotation 103. Incident beam 104 co-aligned with the axis of rotation results in the scanned beam 105 that is swept along a circle. In this illustration, the angle between the axis of rotation and the mirror facet normal is 45 degrees, and the scanned beam is rotated about 360 degrees of azimuth at 0 degrees of elevation. When such a scan mirror is utilized in an optical beam scanner, other components not illustrated for illustrative clarity but are typically included, such as a motor, bearings, and motor controller.

The angular envelope of the scanned beam pattern is also referred to as the field of regard (FOR), especially when the scanned beam is part of a remote sensing system.

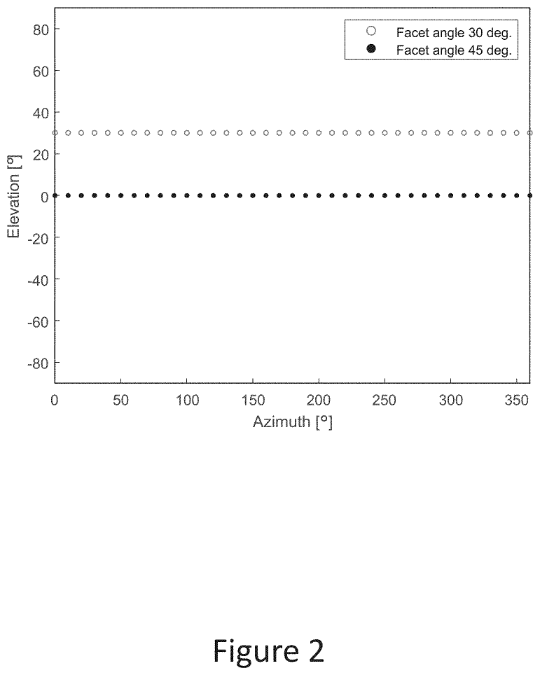

If the incident beam is unchanged but the angle 106 between the axis of rotation and the mirror facet normal is 0-45 degrees, the scanned circle changes offset elevation. The FOR is offset about elevation but is constant for changing azimuth. For example and illustrated in FIG. 2, a mirror facet angle of 45 degrees results in a single elevation line centered at 0 degrees elevation (filled circles), whereas a mirror facet angle of 30 degrees results in a single elevation line centered at 30 degrees above elevation (open circles). The relationship between mirror facet angle and elevation offset is linear.

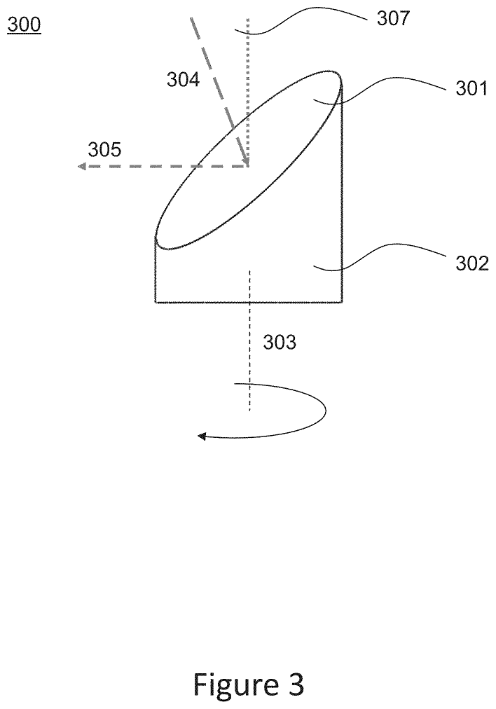

If the beam angle between the axis of rotation and the mirror facet is fixed at 45 degrees and the incident beam is intersects the mirror facet at the position along the rotational axis, but the center of the incident beam is not co-aligned with the rotation axis, the scanned line varies in elevations like a sine wave. As illustrated in FIG. 3, monogon mirror 300 has one reflective facet 301 and other non reflective surfaces, such as 302, both of which rotate about the axis of rotation 303. Incident beam 304 is un-aligned with the axis of rotation results in the scanned beam 305 that is swept along a curve. In this illustration, the angle between the axis of rotation and the mirror facet normal is 45 degrees, and the scanned beam is rotated about 360 degrees of azimuth at varies from 0 degrees of elevation.

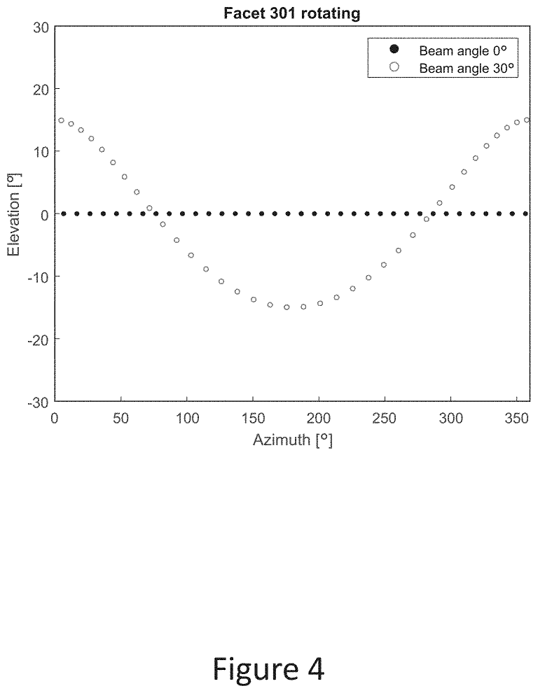

For example and illustrated in FIG. 4, a mirror facet angle of 45 degrees and a beam angle of 0 degrees results in a single elevation line centered at 0 degrees elevation (filled circles), whereas a beam angle of 30 degrees results in a curve that resembles a sinusoid centered at zero degree elevation but varies from this value by up to 15 degrees (open circles).

As evident in the illustrations, these scan mirror configurations are limited in that they can deliver patterns where a single elevation is achievable at a single azimuth for all facet rotation positions. This can be a limitation in applications where more combinations of azimuth and elevation are desirably sampled for remote imaging and other applications. One approach to expand the realized scan angles includes including additional optical beams. In this way, multiple lines and curves samples a greater angular space, but may require additional beams, detectors, and data processing hardware. In cases where a greater angular scan combinations are desired but increased data rates are not required, the approach of adding beam channels increases cost and complexity. Novel scan mirror configurations described in this patents provide means to expand these limitations to fill in the FOR envelope without requiring additional beams or sensing channels.

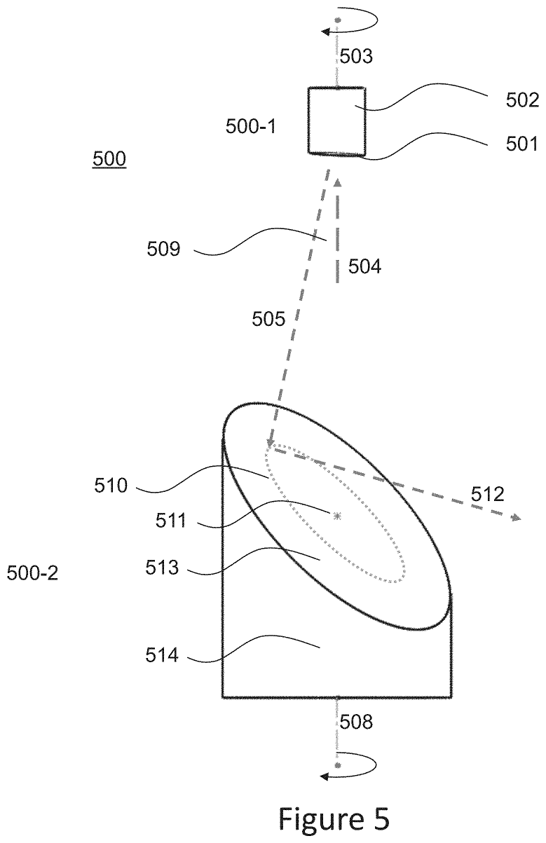

One configuration for expanding the realizable scan pattern and fill in the FOR envelope involves utilizing two monogons, where one monogon has a shallow facet angle and the other has a large facet angle. For instance in FIG. 5, dual monogon scanner 500 is comprised for monogons 500-1 and 500-2. Monogon mirror 500-1 has one reflective facet 501 and other non reflective surfaces, such as 502, both of which rotate about the axis of rotation 503. Monogon mirror 500-2 has one reflective facet 513 and other non reflective surfaces, such as 514, both of which rotate about the axis of rotation 508, which is co-aligned with axis of rotation 503. Incident beam 504 is co-aligned with the axis of rotation and is directed toward mirrored facet 501. Rotation of 500-1 results in the scanned beam 505 that is swept along a circle or loop. The angular radius 509 of this scanned circle or loop depends on the mirror facet angle as described previously. The scanned circle or loop 510 is incident upon mirrored facet 513 of monogon 500-2 and is centered on point 511. Upon a second reflection, a twice scanned beam 512 exits the scanner.

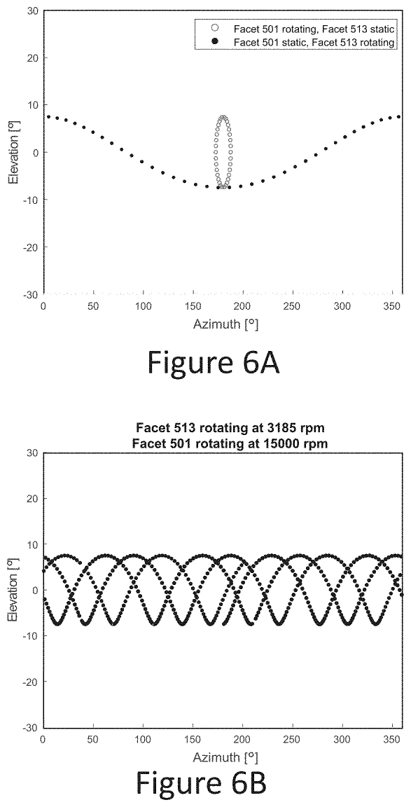

The resulting scanned beam position depends on the rotational position of both monogons. By addressing each scanner separately rotate and stop mechanisms or as varying but nominally constant speeds, or with constant speeds, various final scan beam positions can be realized. For instance and illustrated in FIG. 6A, when monogon facet 501 is rotating but monogon facet 513 is not, a circular scan pattern results (open circles). When monogon facet 513 is rotating but monogon facet 501 is not, a curved scan pattern results (filled circles). FIG. 6B illustrates the condition where both facets 501 and 513 are rotating at 15000 rpm and 3185 rpm, respectively. When both rotate, all combinations of azimuth and elevation that are contained in the FOR can be scanned. The scan pattern line density depends on the relative rotation speeds of the two devices and is preferably greater than 2:1 and less than 20:1. The FOR can be expanded to greater elevation ranges by, for instance, adjusting the facet angle of scanner 500-1.

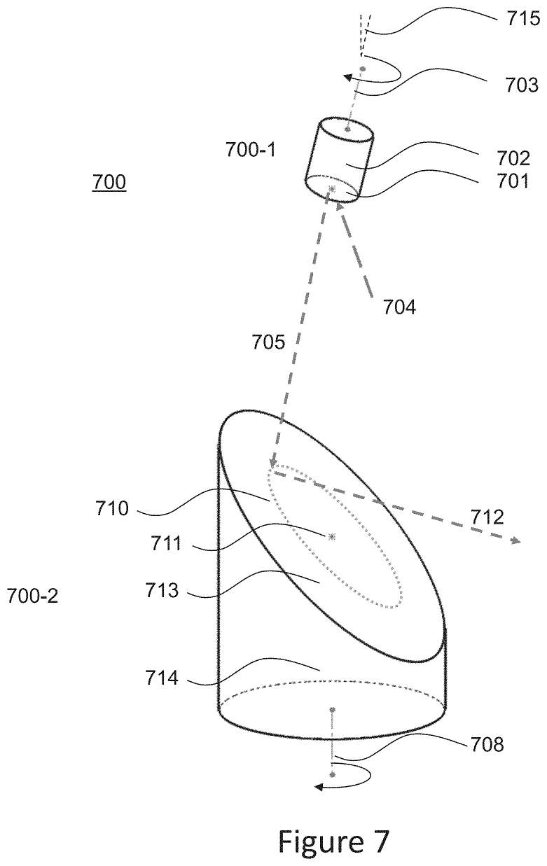

A possible limitation of scanner 500 is that incident beam 504 may occlude first reflected beam 505 as light source generation, redirection, or detection hardware require a finite volume. An improvement upon scanner 500 is described in FIG. 7. Dual monogon scanner 700 is comprised for monogons 700-1 and 700-2. Monogon mirror 700-1 has one reflective facet 701 and other non reflective surfaces, such as 702, both of which rotate about the axis of rotation 703. Monogon mirror 700-2 has one reflective facet 713 and other non reflective surfaces, such as 714, both of which rotate about the axis of rotation 708, which is un-aligned with axis of rotation 703 by tilt angle 715. Incident beam 704 is un-aligned with both axes of rotation and is directed toward mirrored facet 701. Rotation of 700-1 results in the scanned beam 705 that is swept along a circle or loop. The scanned circle or loop 710 is incident upon mirrored facet 713 of monogon 700-2 and is centered on point 711. Upon a second reflection, a twice scanned beam 712 exits the scanner.

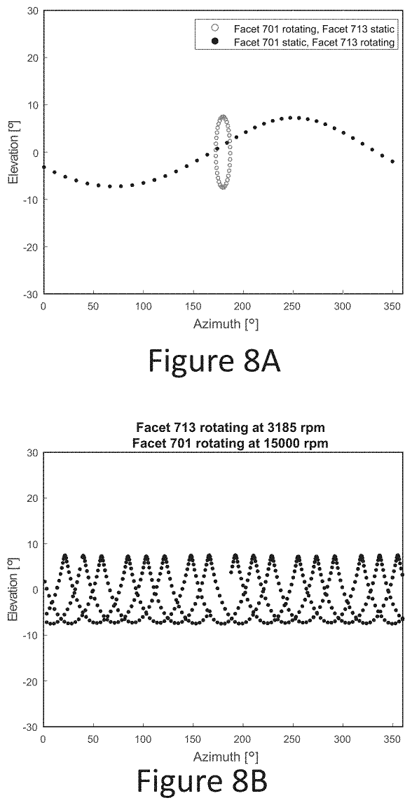

The resulting scanned beam position depends on the rotational position of both monogons. By addressing each scanner separately rotate and stop mechanisms or as varying but nominally constant speeds, or with constant speeds, various final scan beam positions can be realized. For instance and illustrated in FIG. 8A, when monogon facet 701 is rotating but monogon facet 713 is not, a circular scan pattern results (open circles). When monogon facet 713 is rotating but monogon facet 701 is not, a curved scan pattern results (filled circles). FIG. 8B illustrates the condition where both facets 701 and 713 are rotating at 15000 rpm and 3185 rpm, respectively. When both rotate, all combinations of azimuth and elevation that are contained in the FOR can be scanned. The scan pattern line density depends on the relative rotation speeds of the two devices and is preferably greater than 2:1 and less than 20:1. The FOR can be expanded to greater elevation ranges by, for instance, adjusting the facet angle of scanner 700-1 and the angle of the incident beam.

The resulting scan pattern is centered about the horizon 0 degree elevation position. Though judicious design of the beam angle and tilt angle, the resulting FOR is identical between dual monogon scanners 500 and 700, but the latter scanner has volume to contain beam generation, redirection, and detection hardware, as needed to accommodate full system integration.

When the center of the first scanned beam circle or loop 710 is intersects with the axis of rotation of the second monogon scanner, the resulting scan pattern has a elevation scan range that is constant for all azimuth.

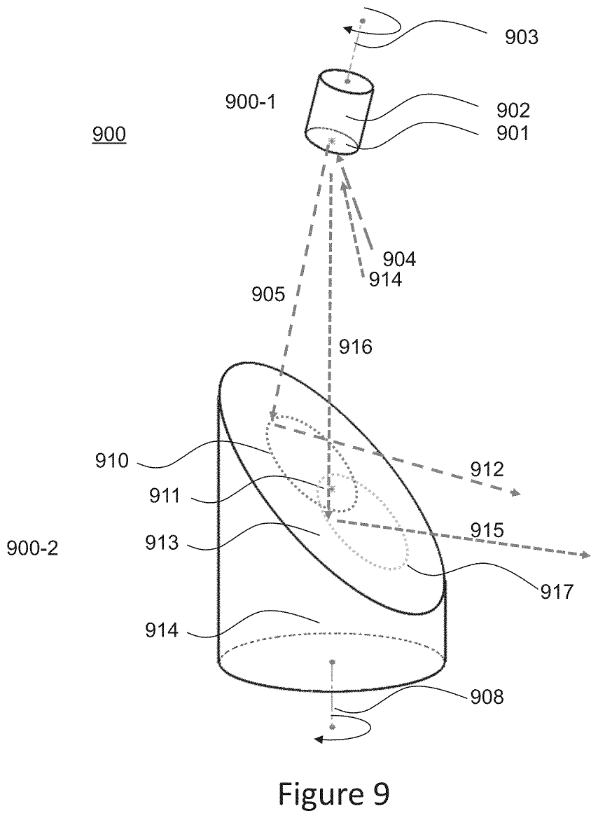

It may be desirable to utilize scanner 700 with two optical beams. For instance, higher sensing data rates may be desired than is possible from a single optical beam, or a larger FOR may be desired but other aspects of the scanner are desirably unchanged. Adding a second incident beam may be challenged by a desire to avoid partial or full occlusion of the two incident beams. An additional configuration of a dual monogon scanner 900 is described in FIG. 9. The scanner is comprised of monogons 900-1 and 900-2. Monogon mirror 900-1 has one reflective facet 901 and other non reflective surfaces, such as 902, both of which rotate about the axis of rotation 903. Monogon mirror 900-2 has one reflective facet 913 and other non reflective surfaces, such as 914, both of which rotate about the axis of rotation 908, which is un-aligned with axis of rotation 903 by a tilt angle. Incident beam 904 is un-aligned with both axes of rotation and is directed toward mirrored facet 901. Rotation of 900-1 results in the scanned beam 905 that is swept along a circle or loop. The scanned circle or loop 910 is incident upon mirrored facet 913 of monogon 900-2 and is not centered on point 911. Upon a second reflection, a twice scanned beam 912 exits the scanner. Incident beam 914 is un-aligned with both axes of rotation and is directed toward mirrored facet 901. Rotation of 900-1 results in the scanned beam 916 that is swept along a circle or loop. The scanned circle or loop 917 is incident upon mirrored facet 913 of monogon 900-2 and is not centered on point 911 and is not concentric with scanned circle or loop 910.

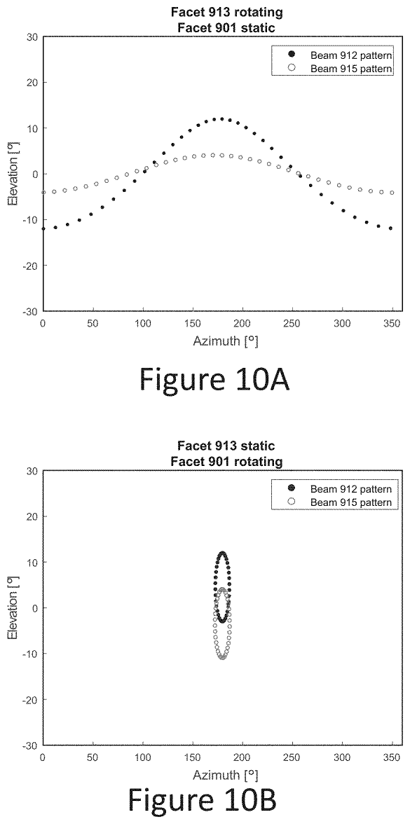

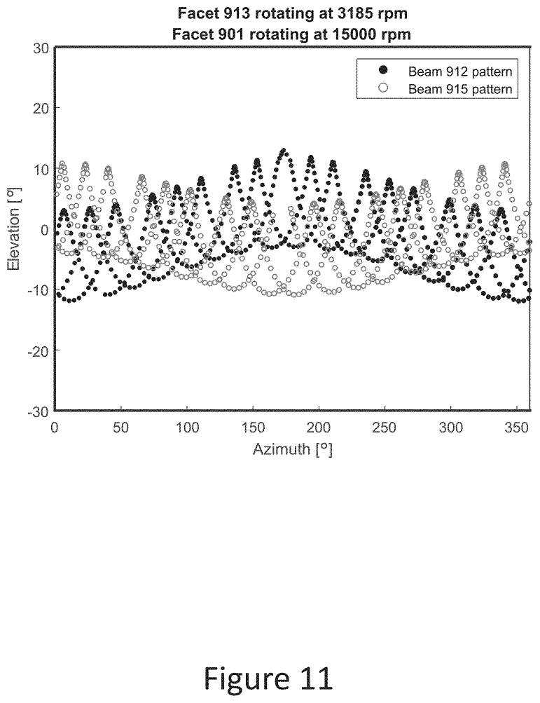

The resulting scanned beam position depends on the rotational position of both monogons. By addressing each scanner separately rotate and stop mechanisms or as varying but nominally constant speeds, or with constant speeds, various final scan beam positions can be realized. For instance and illustrated in FIG. 10A, when monogon facet 913 is rotating but monogon facet 901 is not, two scan curved patterns 912 and 915 result, illustrated in filled circles and open circles, respectively. In shown in FIG. 10B, when monogon facet 901 is rotating but monogon facet 913 is not, two scan circular patterns 912 and 915 result, illustrated in filled circles and open circles, respectively.

FIG. 11 illustrates the condition where both facets 901 and 913 are rotating at 15000 rpm and 3185 rpm, respectively, and two beams are scanned into curved scan patterns 912 and 915, respectively. Both scan patterns are sinusoidal variations about a sinusoid baseline, whose amplitude depends upon the angular arc distance between the center of the scan circle or loop after the first monogon 900-1 and the rotation axis 908 of the second monogon 900-2. Either of the two beam patterns have a larger FOR envelope than the beam arrangement in dual monogon scanner 700 due to the sinusoidal baseline having a greater elevation variation than the constant elevation offsets illustrated in FIG. 8B. However, the offset means that there are some angular combinations within the FOR envelope that cannot be addressed for any of the two monogon rotations. However, since the second beam channel is located at a different initial incident angle, the un-addressable area within the FOR envelope can be reduced.

More than two channels can be utilized; when judiciously placed, the un-addressable area within the FOR envelope can be reduced yet further. When both rotate, all combinations of azimuth and elevation that are contained in FOR can be scanned. The scan pattern line density depends on the relative rotation speeds of the two devices and is preferably greater than 2:1 and less than 20:1. The FOR can be expanded to greater elevation ranges by, for instance, adjusting the facet angle of scanner 900-1 and the angle of either of the incident beams.

It may be desirable to utilize scanner that contains a smaller outer dimensional envelope. The beam placement in scanners 500, 700, and 900 is generally between two monogons. Arranging additional optical elements between the two monogon scanners provides some placement constraints.

In another embodiment, the first monogon is replaced with a beam steering or wedge prism. The shape the steering prism may be similar to the rotating monogon, but it is comprised of a material that is substantially transparent over the wavelength of the optical beam such as glass, semiconductor, ceramic, or plastic.

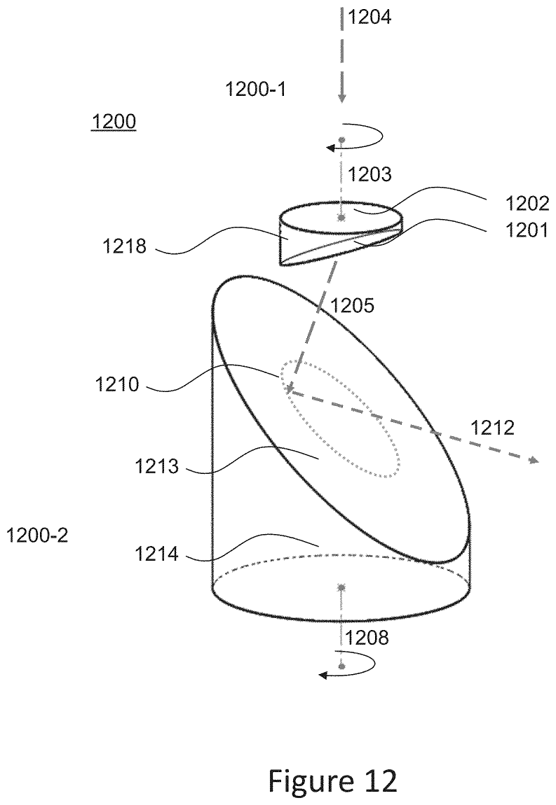

An additional configuration of a scanner 1200 is described in FIG. 12. The scanner is comprised of prism 1200-1 and monogon 1200-2. Prism 1200-1 has two transmissive facets 1201 and 1202 and another surface 1218 that does not intersect any light beams. These surfaces rotate about the prism axis of rotation 1203. Monogon mirror 1200-2 has one reflective facet 1213 and other non reflective surfaces, such as 1214, both of which rotate about the axis of rotation 1208, which is co-aligned with axis of rotation 1203. Incident beam 1204 is aligned with both axes of rotation and is directed toward transmissive facet 1202. Rotation of 1200-1 results in the scanned beam 1205 that is swept along a circle or loop. The scanned circle or loop 1210 is incident upon mirrored facet 1213 of monogon 1200-2 and is centered on the axis of rotation 1208. Upon reflection, a twice scanned beam 1212 exits the scanner.

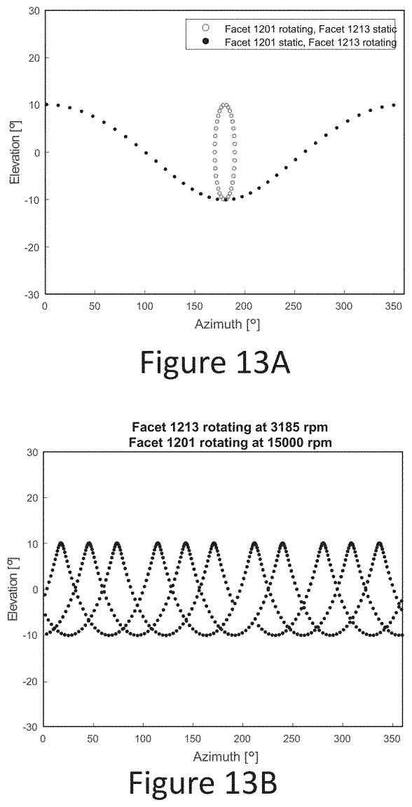

The resulting scanned beam position depends on the rotational position of the monogon and the prism. By addressing each scanner separately rotate and stop mechanisms or as varying but nominally constant speeds, or with constant speeds, various final scan beam positions can be realized. For instance and illustrated in FIG. 13A, when prism facet 1201 is rotating but monogon facet 1213 is not, a circular scan pattern results (open circles). When monogon facet 1213 is rotating but prism facet 1201 is not, a curved scan pattern results (filled circles). FIG. 13B illustrates the condition where both facets 1201 and 1213 are rotating at 3185 rpm and 15000 rpm, respectively. When both rotate, all combinations of azimuth and elevation that are contained in the FOR can be scanned. The scan pattern line density depends on the relative rotation speeds of the two scanners. The FOR can be expanded to greater elevation ranges by, for instance, adjusting the facet angle of prism 1200-1.

The scan circle radius when prism facet 1201 is rotating and monogon facet 1213 is not rotating depends on the index of refraction of the prism material as well as the facet angle. In contrast to a reflective monogon, a greater prism facet angle increases the scan circle angular radius. An increase in refractive index also increases the scan circle angular radius.

One advantage of scanner 1200 over scanner 500, 700, and 900 is that the position of the beam and any other optics may be away from the volume between the two rotating elements, a configuration with some additional flexibility for overall system layout. Since the beam isn't located in the volume between the two rotating optical elements, the volume between them can be reduced, which also reduces the overall system size.

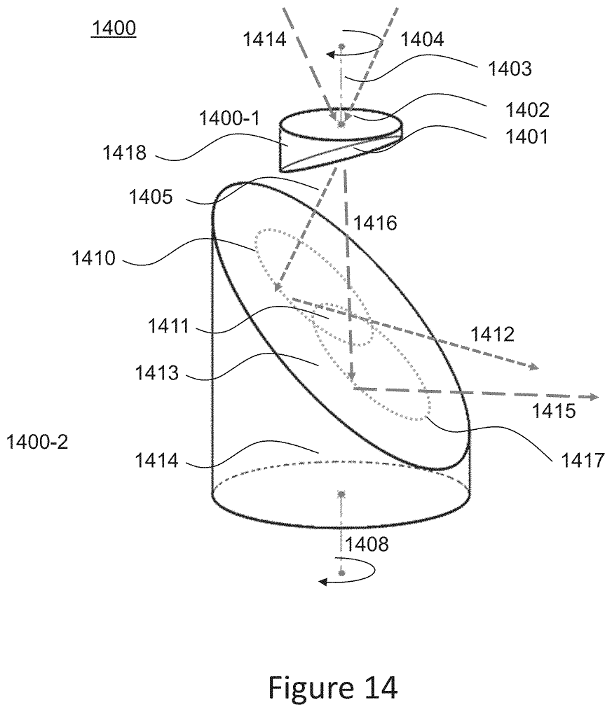

It may be desirable to utilize scanner 1200 with two optical beams. For instance, higher sensing data rates may be desired than is possible from a single optical beam, or a larger FOR may be desired but other aspects of the scanner are desirably unchanged. Adding a second incident beam may be challenged by a desire to avoid partial or full occlusion of the two incident beams. An additional configuration of a dual monogon scanner 1200 is described in FIG. 14.

The scanner is comprised of prism 1400-1 and monogon 1400-2. Prism 1400-1 has two transmissive facets 1401 and 1402 and another surface 1418 that does not intersect any light beams. These surfaces rotate about the prism axis of rotation 1403. Monogon mirror 1400-2 has one reflective facet 1413 and other non reflective surfaces, such as 1414, both of which rotate about the axis of rotation 1408, which is co-aligned with axis of rotation 1403. Incident beam 1204 is un-aligned with both axes of rotation and is directed toward transmissive facet 1402. Rotation of 1400-1 results in the scanned beam 1405 that is swept along a circle or loop. The scanned circle or loop1410 is incident upon mirrored facet 1413 of monogon 1400-2 and is not centered on the axis of rotation 1408. Upon reflection, a twice scanned beam 1412 exits the scanner. Incident beam 1414 is co-aligned with both axes of rotation and is directed toward mirrored facet 1402. Rotation of 1400-1 results in the scanned beam 1416 that is swept along a circle or loop. The scanned circle or loop 1417 is incident upon mirrored facet 1413 of monogon 1400-2 and is not centered on the axis of rotation 1408. Upon reflection, a twice scanned beam 1415 exits the scanner.

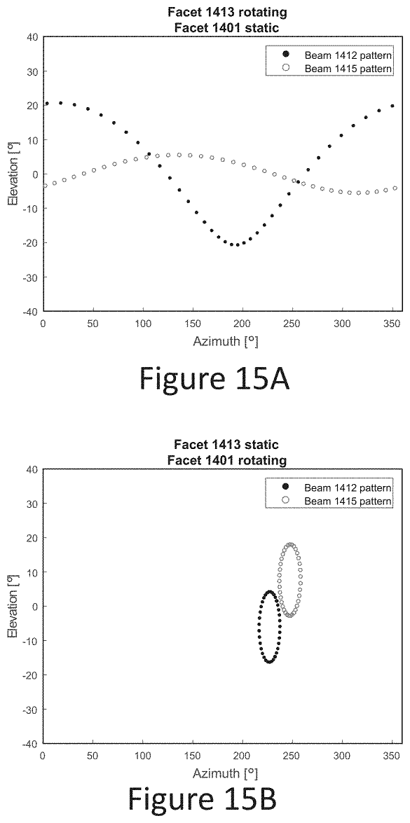

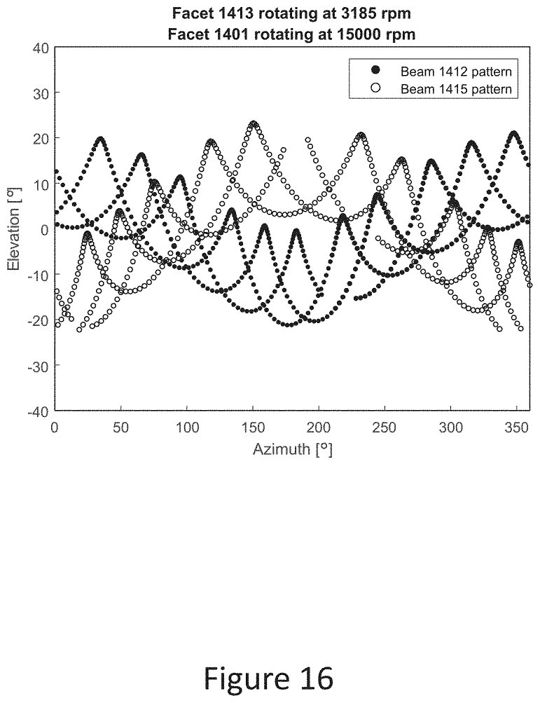

The resulting scanned beam position depends on the rotational position of both prism 1400-1 and monogon 1400-2. By addressing each scanner separately rotate and stop mechanisms or as varying but nominally constant speeds, or with constant speeds, various final scan beam positions can be realized. For instance and illustrated in FIG. 15A, when monogon facet 1413 is rotating but prism facet 1401 is not, two scan curved patterns 1412 and 1415 result, illustrated in filled circles and open circles, respectively. In shown in FIG. 15B, when prism facet 1401 is rotating but monogon facet 1413 is not, two scan circular patterns 1412 and 1415 result, illustrated in filled circles and open circles, respectively. FIG. 16 illustrates the condition where both facets 1401 and 1413 are rotating at 15000 rpm and 3185 rpm, respectively, and two beams are scanned into curved scan patterns 1412 and 1415, respectively. Both scan patterns are sinusoidal variations about a sinusoid baseline, whose amplitude depends upon the angular arc distance between the center of the scan circle or loop after the prism 1400-1 and the rotation axis 1408 of the monogon 1400-2. Either of the two beam patterns have a larger FOR envelope than the beam arrangement in dual monogon scanner 1200 due to the sinusoidal baseline having a greater elevation variation than the constant elevation offsets illustrated in FIG. 13B.

However, the offset means that there are some angular combinations within the FOR envelope that cannot be addressed for any of the two optical elements' rotations. However, since the second beam channel is located at a different initial incident angle, the un-addressable area within the FOR envelope can be reduced. More than two channels can be utilized; when judiciously placed, the un-addressable area within the FOR envelope can be reduced yet further. When both rotate, all combinations of azimuth and elevation that are contained in FOR can be scanned. The scan pattern line density depends on the relative rotation speeds of the two devices and is preferably greater than 2:1 and less than 20:1. The FOR can be expanded to greater elevation ranges by, for instance, adjusting the facet angle of scanner 1400-1 and the angle of either of the incident beams.

The total volume envelope of scanner 1400 may be desirably reduced further. In one embodiment, the rotating prism 1400-1 is replaced with a thin plate containing an inline polarization grating and employs highly polarization-sensitive diffraction. Since polarizations gratings are typically patterned in thin liquid crystal layers, the system can be implemented with reduced thickness and mass. Inline polarization gratings can be prepared for a range of beam wavelengths and scan angles, both of which depend on various parameters, including grating period. The rotating polarization grating results in a similar to scan circle or loop 1210 and as such, can be used in a two rotating optical element scanner such as those described here to obtain total scan patterns similar to those shown in FIG. 13B and FIG. 16.

Scanners comprised of two rotating prism elements or two rotating inline polarization gratings have been described before, but are incapable of demonstrating azimuthal scan ranges up to 360 degrees. To achieve this capability, the second of the two rotating elements should contain a reflective facet that receives the first scanned beam for all rotations positions of the first scanner, and the second scanner should include at least one reflective facet.

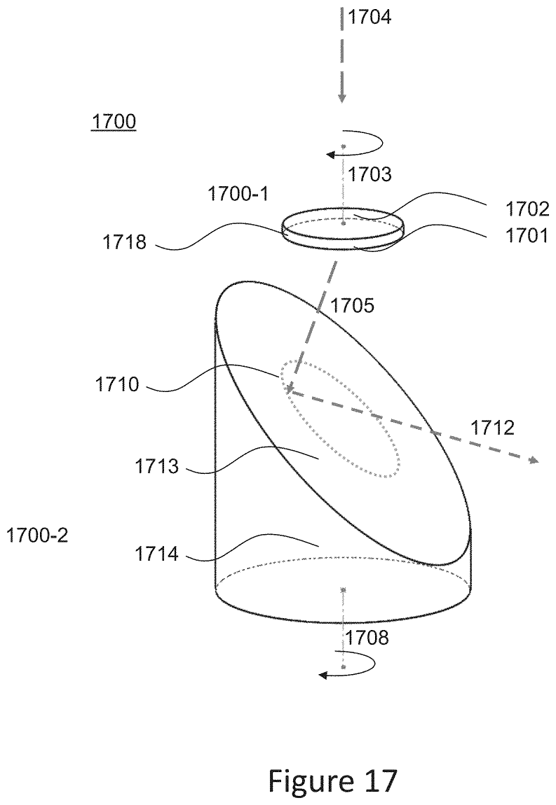

An additional configuration of a scanner is described in FIG. 17 which utilizes a rotating inline polarization grating. Such a grating may be advantageous because they may be patterned in thin liquid crystal layers that may be micrometers thick and exhibit an advantageous property of scaling to larger areas without increases in overall thickness, unlike refractive prisms. They may enable systems with smaller thickness, lower mass, lower total electrical power use, and improved aspect ratio.

The scanner 1700 is comprised of grating 1700-1 and monogon 1700-2. Grating 1700-1 has two transmissive facets 1701 and 1702 and another surface 1718 that does not intersect any light beams. These surfaces rotate about the grating axis of rotation 1703. Monogon mirror 1700-2 has one reflective facet 1713 and other non reflective surfaces, such as 1714, both of which rotate about the axis of rotation 1708, which is co-aligned with axis of rotation 1703. Incident beam 1704 is aligned with both axes of rotation and is directed toward transmissive facet 1702. Rotation of 1700-1 results in the scanned beam 1705 that is swept along a circle or loop. The scanned circle or loop 1710 is incident upon mirrored facet 1713 of monogon 1700-2 and is centered on the axis of rotation 1708. Upon reflection, a twice scanned beam 1712 exits the scanner.

An inline polarization grating may be constructed in a variety of ways but one manner is as follows. A grating includes a primary substrate (for instance, glass), a photo-alignment layer which imparts a periodic alignment condition, a nematic liquid crystal layer (which may be switchable or polymerizable), and adhesion layer (or another photo-alignment layer), and an additional enclosing substrate (which may also be a glass substrate). Some unique aspect of such gratings are that they can be made to transmit circularly polarized input light into a single optical mode (direction) with high efficiencies, including above 98%. With rotation, that single mode can be rotating about the axis of rotation in a manner similar to that of a rotating monogon or a rotating prism.

Rotating monogons such as those described here may be simple truncated mirrors constructed from aluminum, beryllium, glass, silicon or other appropriate materials and may employ high reflectivity coatings made from various metals or multilayer dielectrics, as would be identified for high scanner total transmission and specific to scanned beam wavelength or wavelengths.

Alternatively, rotating monogons may be constructed from other structures, including those that may involve refraction or reflection at multiple interfaces, but serve to scan out a circle or line as described in these embodiments. Those other structures include a pentaprism, a pentamirror, or a dual reflection open mirror, all of which are forms of monogons that may include rotational alignment correction due to their dual reflection structures. Alternatively, the rotating monogons may be constructed of structures that utilize total internal reflection, such as a cube prism or ball prism.

A key aspect of the previously described embodiments is the inclusion of two rotating optical elements possessing co-aligned or nearly co-aligned axes of rotation where a difference between them may be less than 45 degrees, and in particular less than 20 degrees. A key aspect of the resulting scan patterns of such systems is the production of a scan envelope that ranges up to 360 degrees of azimuth, which in general cannot be produced by other categories of scanners, such as non-monogon polygon scanners, galvanometers, flexure mirrors, microelectromechanical mirrors, and other fast steering mirrors.

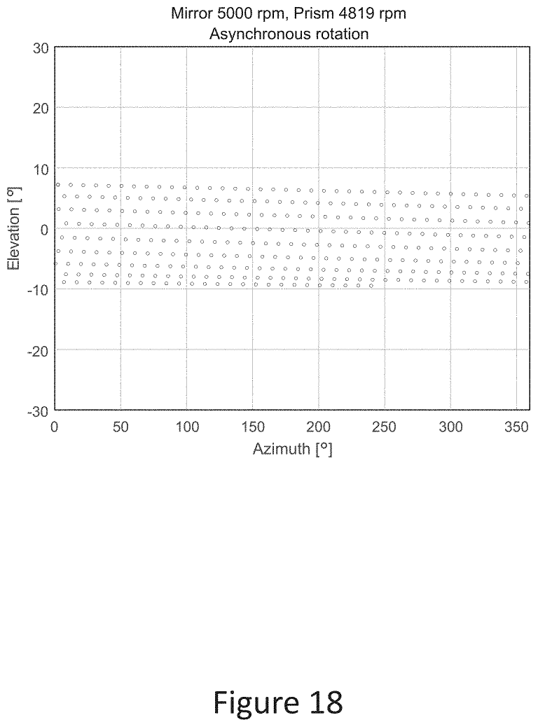

A scanner comprised of two rotating optical elements generates curved scan patterns in all of the illustrations described above. When the two rotation speeds of the optical elements approach the same value, the curvature of the scan patterns reduces. For example, and illustrated in FIG. 18, if the two optical elements shown in FIG. 12 are rotated at speeds that differ by approximately 4%, the scan field patterns are nearly linear, although slanted. This may be desired, as sampling patterns in some prior art remote sensing systems employ rectilinear sampling patterns. This is a special case of the general configuration of using two rotating optical elements to scan two dimensional angular space and is not unique to a prism and a monogon. The same pattern may arise in an in-line polarization grating and a monogon, as well as two monogons, at the various angles of incidence as in the optical systems previously described.

When the instantaneous rotation speeds of the two optical elements are exactly equal, the scan pattern and scan envelope collapse into a single line. As the first optical element rotates, the position on the second element upon which the first scanned beam lands continuously changes, but the elevation angle at which it meets the second element does not, resulting in a beam that is scanned 360 degrees in the azimuth plane but at a single elevation, like the singly rotating monogon illustrated in FIG. 1.

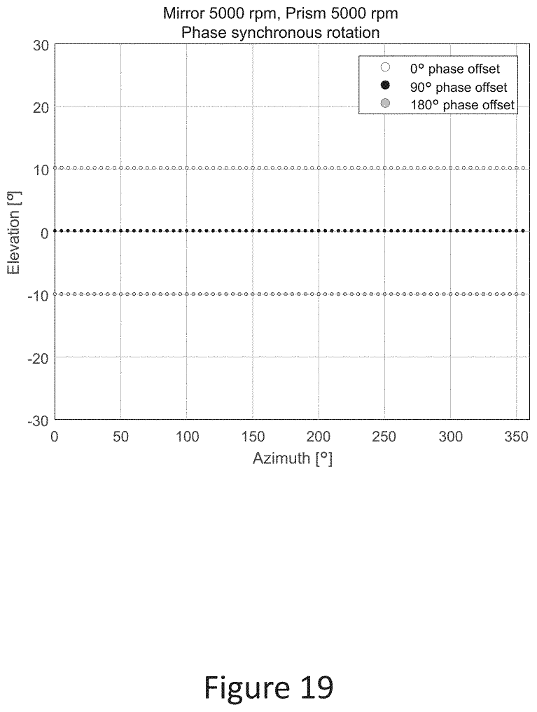

An example scan pattern resulting from this configuration is illustrated in FIG. 19. A unique difference between identically rotating dual optical elements and singly rotating optical elements is that unique elevation scans can be achieved by changing the rotation phase difference between the two optical elements, as opposed to changing the beam incidence angle. As shown in FIG. 19, three different elevation scans are shown for three rotation conditions. In all three cases the two optical elements are rotating at the same speed of 5000 rpm, but the phase difference between the two optical elements are 0, 90 and 180 degrees. In this case, the total elevation span is 20 degrees. By changing the relative phase, each of the elevation lines can be addressed separately.

One advantage of this configuration is that the scan pattern is flat across elevation, enabling rectilinear field sampling. Another benefit, as mentioned previously, is the ability to use a single ranging/sensing channel comprised of light source, detector, and sensing electronics, to scan two angular dimensions using only rotating devices, which is more energetically favorable than devices that constantly accelerate and decelerate in opposing directions. Another benefit is that the phase difference can be controlled in response to changing conditions through the use of various control system architectures, enabling the ability to scan temporally varying fields of regard in a periodic manner, or in response to specific detected conditions. For instance, the elevation range of interest may change when a moving vehicle is moving up or down in physical elevation, or if specific agents are detected that merit higher temporal or spatial resolution sampling.

There are various means to control two rotating optical elements to be exactly synchronous and the current invention is not limited to a single implementation. The rotating optical elements may use control systems that utilized phase locked loops, for instance. The two scanners may be synchronized to each other, or each may be synchronized to a single reference clock signal.

The synchronization may also employ conventional PID controllers or operational amplifiers which may adjust speed control to minimize some error signal derived from, for instance, the timing difference between two characteristics signals derived from the two rotating optical elements, such as the outputs of hall sensors or angle encoders occurring once or more per rotation.

Phase locked and rotation synchronized rotating machines have been described previously; a key aspect of one implementation of the current invention is their implementation in rotating optical elements comprised of monogon, prism, or grating scanners.

That which is claimed:

1. An optical beam scanner, comprising:
a first optical beam steering device having a first surface thereon, which is configured to redirect a first optical beam incident thereon through reflection, refraction and/or diffraction of the first optical beam; and
a second optical beam steering device having a second surface thereon, which is configured to reflect the redirected first optical beam incident thereon at a scanning target when both first and second surfaces are rotating about respective first and second axes of the first and second optical beam steering devices and the redirected first optical beam is tracing an uninterrupted loop on the second surface.

2. The scanner of claim 1, wherein the first optical beam steering device is configured as a first monogon, a first prism, or a first grating; and wherein the second optical beam steering device is configured as a second monogon.

3. The scanner of claim 2, wherein the first and second axes are collinear.

4. The scanner of claim 1, wherein the first and second surfaces are mirrored surfaces.

5. The scanner of claim 2, further comprising a first light source configured to project the first optical beam to a first portion of the first surface.

6. The scanner of claim 5, wherein the first prism is disposed between the first light source and the second monogon.

7. The scanner of claim 5, further comprising a second light source configured to project a second optical beam to a second portion of the first surface.

8. The scanner of claim 7, wherein the first surface is configured to reflect, refract or diffract the second optical beam; and wherein the second surface is configured to redirect the reflected second optical beam incident thereon at a corresponding scanning target when both first and second surfaces are rotating about respective first and second axes of the first and second optical beam steering devices.

9. The scanner of claim 8, wherein the first and second portions of the first surface partially overlap.

10. In an optical beam scanner including: (i) a first optical beam steering device having a first surface thereon, which is configured to reflect, refract or diffract a first optical beam incident thereon, and (ii) a second optical beam steering device having a second surface thereon, which is configured to redirect the reflected, refracted or diffracted first optical beam incident thereon at a scanning target, a method of operating, comprising:
rotating the first and second optical beam steering devices about respective first and second axes, and at respective first and second rates.

11. The method of claim 10, wherein the first rate is greater than the second rate.

12. The method of claim 11, wherein the first rate is at least four (4) times greater than the second rate.

13. The method of claim 12, wherein the first optical beam steering device is configured as a first monogon, a first prism or a first grating; and wherein second optical beam steering device is configured as a second monogon.

14. The method of claim 13, wherein the first and second axes are collinear.

15. The method of claim 10, wherein the first and second surfaces are mirrored surfaces.

16. The method of claim 14, wherein the scanner further includes a first light source configured to project the first optical beam to a first portion of the first surface; and wherein the first prism is disposed between the first light source and the second monogon.

17. The method of claim 13, wherein the scanner further includes a first light source configured to project the first optical beam to a first portion of the first surface, and a second light source configured to project a second optical beam to a second portion of the first surface.

18. The method of claim 17, wherein the first surface is configured to reflect, refract or diffract the second optical beam; and wherein the second surface is configured to redirect the reflected, refracted or diffracted second optical beam incident thereon at a corresponding scanning target during said rotating.

19. The method of claim 18, wherein the first and second portions of the first surface partially overlap.

20. The method of claim 10, wherein the first and second rates are within 5% of each other.
